(19) United States
(12) Patent Application Publication
(10) Pub. No.: US 2007/0038871 A1
(43) Pub. Date: Feb. 15, 2007

(54) Method for protecting information carrier comprising an integrated circuit

(75) Inventors: Josephus Arnoldus Henricus Maria Kahlman, Eindhoven (NL); Antonius Hermanus Maria Akkermans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/576,393

(22) PCT Filed: Oct. 18, 2004
(86) PCT No.: PCT/IB04/52125

§ 371 Date: Apr. 20, 2006

(30) Foreign Application Priority Data
Oct. 23, 2003 (EP) 03103931.6

(51) Int. Cl. G06F 12/14

(52) U.S. Cl. 713/193

(57) ABSTRACT

The invention relates to an information carrier comprising a integrated circuit (1) representing a physical unclonable function. To make the integrated circuit more secure it is proposed that it comprises: an input means (7) for receiving a challenge signal for challenging said integrated circuit (1), a response signal providing means (2) for providing a response data signal in response to said challenge data signal, an output means (8) for outputting said response data signal, and a delay means (3, 5, 9-12) for delaying and/or prohibiting the provision and/or the output of said response data signal.

The invention relates to an information carrier comprising an integrated circuit representing a physical unclonable function. The invention relates further to such an integrated circuit itself, to a method of providing a physical unclonable function and to a computer program for implementing said method.

Non-clonable devices are known in the art. They are often implemented as optical challenge and response systems which are used in crypto- and security devices, smart cards, eBanking, internet transactions etc. Mostly the relation between the challenge and the response is a non-reversible mathematical function. The problem is that a non-trusted party who generates the response for a certain challenge can hack the system.

The use of “physically unclonable functions” (PUFs) for security purposes is known, e.g. from the article “Physical One-Way Functions” Ravikanth Pappu et al., Vol. 297 SCIENCE, 20/09/2002. Incorporating a PUF into a device such as a smart card, chip, or storage medium makes it extremely difficult to produce a “clone” of the device. “Clone” means either a physical copy of the device or a model that is capable of predicting the input-output behavior of the device with reliability. The difficulty of physical copying arises because the PUF manufacturing is an uncontrolled process and the PUF is a highly complex object. Accurate modeling is extremely difficult because of the PUF's complexity; slightly varying the input results in widely diverging outputs. The uniqueness and complexity of PUFs makes them well suited for identification, authentication or key generating purposes.

Optical PUFs can consist of a piece of, e.g., epoxy containing glass spheres, air bubbles or any kind of transparent scattering or reflecting particles. The epoxy can also be replaced by some other transparent means. Shining a laser through a PUF produces a speckle pattern which strongly depends on properties of the incoming wave front and on the internal structure of the PUF. The input (wave front) can be varied by shifting or tilting the laser beam or by changing the focus. The wave front can also be changed by selecting pixels out of the beam by means of selective blocking, e.g., with micro mirrors (DMDs) or by applying a pixel-dependent phase change. Variation of the wave front can be cheaply realized by placing a spatial light modulator (SLM) in the path of the laser beam. It is a disadvantage of such optical PUFs using laser light that they are expensive and not sufficiently robust It is therefore an object of the invention to provide an information carrier which is difficult to clone, cheap and robust. It is a further object of the invention to provide an integrated circuit for use in such an information carrier.

The object is achieved according to the present invention by an information carrier as claimed in claim 1.

The invention is based on the recognition that a PUF is in fact a large capacity storage system. The characterization time T_{char}, being the time required for complete characterization of the PUF, is a direct measure of the difficulty to clone the PUF. T_{char} depends on the product of the capacity C and the response time T_{data} i.e. the time required for the PUF to output a response to a given challenge, hence T_{char}=C T_{data}. A high response time and medium-capacity storage system thus fulfills the PUF requirements to be achieved according to the invention. I.e., according to the invention the response signal to be outputted is deliberately delayed to make it more difficult to get (read) a high number of challenge—response pairs which are required to clone the PUF in a reasonable time, or the output of the response signal is even completely prohibited, preferably when a maximum number of responses is exceeded. In this way a clone attempt is detected and the PUF is blocked.

In an embodiment, the information carrier according to the invention has the features claimed in claim 2. The memory, for instance, stores a database, e.g. in the form of a look-up table implemented as a ROM-table in the integrated circuit. Such ROM storage means are commercially available and are cheap.

In another embodiment, the information carrier according to the invention has the features claimed in claim 3. The encryption unit can replace the memory or be present in addition to it. Examples of encryption functions are RSA, (triple-)DES, NTRU and linear shift registers. In this embodiment (part of) the response data are not stored, but are computed by the encryption unit. In this embodiment the required storage space for storing the challenge—response pairs is limited.

In another embodiment, the information carrier according to the invention has the features claimed in claim 4. It was found that adding a noise to the responded (generally analogue) data from the memory increases an integration time for producing reliable (generally digital) data. Assuming a data rate T_{data}=10s and C =10 Mbyte, a characterization time T_{char}=3.2 years is caused. This makes the integrated circuit practically unclonable. Preferably, the delay means then comprise a noise source by which a noise signal can be added to the response signal prior to outputting the response signal.

In another embodiment, the information carrier according to the invention has the features claimed in claim 5. The noise source is thus integrated in the read-out mechanism which additionally reduces costs and prevents counterfeiting. E.g. the data is stored in inherent low SNR storage cells, so that long integrations times are required to retrieve the data reliably. In particular, for delaying the response data signal, a noisy read-out amplifier is provided. The noise source is thus integrated in the amplifier in this embodiment of the invention which additionally reduces costs and avoids counterfeiting by opening the chip and disable the noise source.

In other embodiments, the information carrier according to the invention has the features claimed in claims 6 or 7. The response time can be increased by limiting the amount of power available to the integrated circuit, so that after a challenge-response cycle the information carrier needs some time to be reloaded. The time for reloading can be determined by the time for loading a buffer, e.g., a capacitor arranged in the integrated circuit.

In another embodiment, the information carrier according to the invention has the features claimed in claim 8, so as to make the integrated circuit more secure. In this embodiment a noise source is not necessarily required.

An integrated circuit according to the invention is defined in claim 9. A method of providing a PUF is defined in claim 10. A computer program for implementing said method on a computer is defined in claim 11. These can be developed further in the same or similar ways as explained above with reference to the information carrier.

The invention will now be described by way of examples with reference to the drawings, in which:

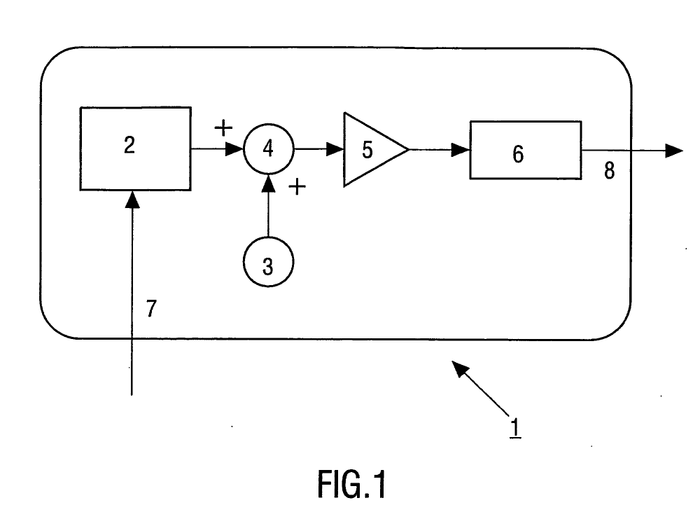

FIG. 1 shows a first embodiment of an integrated circuit for an information carrier according to the invention;

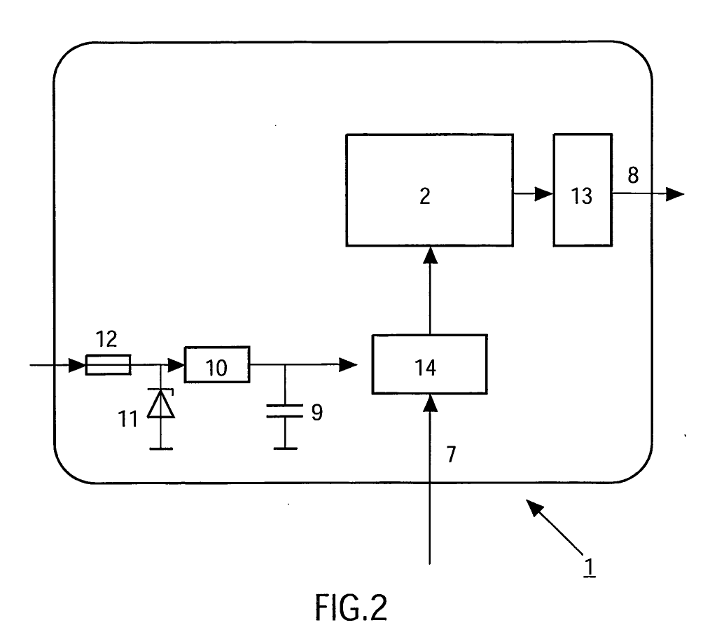

FIG. 2 shows a second embodiment of an integrated circuit for an information carrier according to the invention.

The integrated circuit 1 shown in FIG. 1 contains a look-up table 2, which can be implemented as a ROM-table. Therein, pairs of challenge data and response data are stored for this specific integrated circuit which represents a PUF. The look-up table 2 can be challenged with a challenge data signal provided at an input terminal 7, and will then respond by a corresponding response data signal stored in the look-up table for this particular challenge data signal. Further, the integrated circuit 1 comprises a noise source 3 generating a noise signal which is added to the response signal outputted from the look-up table 2 by an adder 4. The delayed response data signal is further amplified by an amplifier 5 and integrated by integration means 6, which may also be provided outside of the integrated circuit 1, but are provided to produce reliable data. The delayed, amplified and integrated response data signal is then outputted at an output terminal 8.

By use of this noise signal the signal-to-noise ratio of the response data signal is made so low that reliable data can only be retrieved after a long integration of the provided response signal. Since the characterization time T_{char}, i.e. the time required for complete characterization of the PUF, is a direct measure of the difficulty to clone the PUF and depends on the product of the capacity C and the data rate T_{data}, this extension of the integration time by use of the noise signal leads to an extension of the characterization time, i.e. it takes a very long time to clone the PUF.

In another embodiment the signal-to-noise ratio of the response data signal is lowered by the manipulation of the read-out mechanism of the storage system, e.g. by storing a small signal amplitude into the storage cells.

Another embodiment of a low-data rate, medium-capacity integrated circuit according to the invention is shown in FIG. 2. In addition to or alternatively to the look-up table 2 the integrated circuit I of this embodiment comprises an encryption unit 13 which can generate a response data signal in response to a challenge data signal. The power required for one challenge-response cycle is stored in a power buffer, e.g., a capacitor 9 which is charged by a limited current. After performing a challenge-response cycle the capacitor 9 is empty, and reloading will last a predetermined time. The time for loading the capacitor 9 is determined by a resistor 10. A Zener-diode 11 limits the input power which is necessary in order to prevent fraud. A fuse 12 is provided to protect the integrated circuit 1.

The integrated circuit 1 may comprise distinct sub-systems, each having a power supply. In a variant of the embodiment shown in FIG. 2 the power per sub-system, e.g. per Flip-Flop, is limited. This has the advantage that physical attacks are much more difficult due to a distributed power limitation and that only the security related part of the integrated circuit is made bitrate related.

Further, a counter 14 is provided in an embodiment which counts the numbers of challenge attempts so that the maximum number of challenge attempts can be limited.

Further, the number of challenge attempts can be limited by the physics of the read-out system, e.g. by the use of destructive reading in a Ferro Electric RAM without the presence (or disabled) re-write hardware.

To check if the information carrier is authenticated an appropriate reading device is required. Such a device contains a storage means in which challenges and assigned responses corresponding to the integrated circuit are stored. If, e.g., a smart card is inserted into the device, the device challenges the smart card and detects the responded data. The responded data are compared with the assigned responses, and in case the responded data and the assigned responses are identical the user of the smart card is authenticated. In case there is a difference between the responded data and the assigned responses stored in the database the user of the smart card is not authenticated. The authenticating process can also be implemented remotely, e.g. via the Internet. In this case the challenges and responses are communicated between the information carrier and the reading device via a communication channel.

The invention refers to an information carrier containing a non-clonable IC. 20 According to the art ICs are non-clonable, if the challenge space, i.e. the complete set of all challenges, is made very large. The invention provides a non-clonable IC with a medium size challenge space. The IC is made secure by extending the time for obtaining a response after each challenge.

1. Information carrier comprising a integrated circuit (1) representing a physical unclonable function comprising:
an input means (7) for receiving a challenge signal for challenging said integrated circuit (1),
a response signal providing means (2) for providing a response data signal in response to said challenge data signal,
an output means (8) for outputting said response data signal, and
a delay means (3, 5, 9-12) for delaying and/or prohibiting the provision and/or the output of said response data signal.

2. Information carrier as claimed in claim 1, characterized in that said response signal providing means comprise a memory (2) for storing pairs of challenge data and associated response data.

3. Information carrier as claimed in claim 1, characterized in that said response signal providing means (2) comprise a response signal generation means (13), in particular an encryption unit, for generating a response data signal in response to a challenge data signal.

4. Information carrier as claimed in claim 1, characterized in that said delay means comprise a noise source (3) for adding a noise signal to the response signal provided by said response signal providing means (2).

5. Information carrier as claimed in claim 1, characterized in that said delay means comprise a noisy read-out means, in particular a noisy read-out amplifier for amplifying the response signal provided by said response signal providing means (2).

6. Information carrier as claimed in claim 1, characterized in that said delay means comprise limiting means (9-12) for restricting the number of response data signals provided and/or outputted per time unit.

7. Information carrier as claimed in claim 6, characterized in that said limiting means comprise means (9-12) for limiting the amount of power available per time unit.

8. Information carrier as claimed in claim 1, characterized in that said delay means comprise a counter means (14) for limiting the number of responses, in particular the total number of responses or the number of times the response to a given challenge can be provided, of said integrated circuit (1).

9. Integrated circuit (1) representing a physical unclonable function, in particular for use in an information carrier, comprising:
an input means (7) for receiving a challenge signal for challenging said integrated circuit (1),
a response signal providing means (2) for providing a response data signal in response to said challenge data signal,
an output means (8) for outputting said response data signal, and
a delay means (3, 5, 9-12) for delaying and/or prohibiting the provision and/or the output of said response data signal.

10. Method of providing a physical unclonable function comprising the steps of:
receiving a challenge signal for challenging said integrated circuit (1),
providing a response data signal in response to said challenge data signal,
outputting said response data signal, and
delaying and/or prohibiting the provision and/or the output of said response data signal.

11. Computer program comprising program code means for causing a computer to carry out the steps of the method as claimed in claim 10 when said computer program is run on a computer.
